(19) United States
(12) Patent Application Publication
(10) Pub. No.: US 2011/0238910 A1
(43) Pub. Date: Sep. 29, 2011

(54) DATA STORAGE SYSTEM AND SYNCHRONIZING METHOD FOR CONSISTENCY THEREOF

(75) Inventors: Che-Jen Wang, Hsin-Chu (TW); Cheng-Yi Huang, Hsin-Chu (TW); Hung-Ming Chien, Hsin-Chu (TW)

(73) Assignee: PROMISE TECHNOLOGY, INC, Hsin-Chu (TW)

(21) Appl. No.: 12/901,534

(22) Filed: Oct. 10, 2010

(30) Foreign Application Priority Data
Mar. 25, 2010 (TW) 099108812

(51) Int. Cl. G06F 12/00

(52) U.S. Cl. 711/114; 711/E12.001

(57) ABSTRACT

The invention discloses a data storage system and a synchronizing method for consistency thereof, especially for the data storage system specified in RAID 5 architecture. The data storage system according to the invention includes N storage devices, where N is an integer equal to or larger than 3. The synchronizing method according to the invention performs writing commands for the designated storage device among the N storage devices, and reading commands for the other (N−1) storage devices, to reduce synchronization time of the data storage system.

### CROSS-REFERENCE TO RELATED APPLICATION

This utility application claims priority to Taiwan Application Serial Number 099108812, filed Mar. 25, 2010, which is incorporated herein by reference.

### BACKGROUND OF THE INVENTION

1. Field of the Invention

The invention relates to a data storage system and a synchronizing method for consistency thereof, especially for the data storage system specified in RAID 5 architecture. And in particular, the synchronizing method according to the invention can significantly reduce synchronization time of the data storage system according to the invention.

2. Description of the Prior Art

With more and more amount of user data stored as demanded, Redundant Array of Independent Drives (RAID) systems have been widely used to store a large amount of digital data. RAID systems are able to provide high availability, high performance, or high volume of data storage volume for hosts.

The RAID system utilizes various technologies known as RAID levels, and also to be divided into RAID 0, RAID 1, RAID 2, RAID 3, RAID 4, RAID 5, and RAID 6. Each RAID level of technology has its own advantages and disadvantages.

Constitution of the well-known RAID system includes a RAID controller and a RAID composed of a plurality of disk drives. The RAID controller is coupled to each disk drive, and defines the disk drives as one or more logical disk drives selected among RAID 0, RAID 1, RAID 2, RAID 3, RAID 4, RAID 5, RAID 6, and others.

Please refer to FIG. 1A, the architecture of a typical data storage system 1 specified in RAID 5 architecture of prior art is illustratively shown in FIG. 1A.

As shown in FIG. 1A, the data storage system 1 includes a controller 10 and N storage devices (12a˜12d). Because the data storage system 1 shown in FIG. 1A uses RAID 5 of technology, the data storage system 1 needs at least three storage devices. Therefore, N is an integer equal to or larger than 3. FIG. 1A illustratively shows four storage devices (12a, 12b, 12c, 12d) as an example. The controller 10 is capable of generating (reconstructing) redundant data which are identical to data to be read. In this case of utilizing RAID 5 of technology, the controller 10 generates redundant data by Exclusive OR (XOR) operation.

In practical application, each of the storage devices (12a, 12b, 12c, 12d) can be a tape drive, a disk drive, a memory device, an optical storage drive, a sector corresponding to a single read-write head in the same disk drive, or other equivalent storage devices.

Also as shown in FIG. 1A, the controller 10 is respectively coupled to each of the storage devices (12a, 12b, 12c, 12d). FIG. 1A also illustratively shows an application I/O request unit 11. The application I/O request unit 11 is coupled to the controller 10. In practical application, the application I/O request unit 11 can be a network computer, a mini-computer, a mainframe, a notebook computer, or any electronic equipment need to read data in the data storage system 1, e.g., a cell phone, a personal digital assistant (PDA), a digital recording apparatus, a digital music player, and so on.

When the application I/O request unit 11 is a stand-alone electronic equipment, it can be coupled to the data storage system 1 through a transmission interface such as a storage area network (SAN), a local area network (LAN), a serial ATA (SATA) interface, a fiber channel (FC), a small computer system interface (SCSI), and so on, or other I/O interface such as a PCI express interface. In addition, when the application I/O request unit 11 is a specific integrated circuit device or other equivalent devices capable of transmitting I/O read requests, it can send read requests to the controller 10 according to commands (or requests) from other devices, and then read data in the storage devices (12a˜12d) via the controller 10.

The controller 10 and the storage devices (12a˜12d) of the data storage system 1 can not only be placed in an enclosure, but also be separately placed in different enclosures. In practical application, the controller 10 can be coupled to the data storage devices (12a˜12d) through transmission interfaces such as FC, SCSI, SAS, SATA, PATA, and so on. If the data storage devices (12a˜12d) are disk drives, each of data storage devices (12a, 12b, 12c, 12d) could be different interfaces of disk drives such as FC, SCSI, SAS, SATA, PATA, and so on. The controller 10 can be a RAID controller or a controller capable of generating redundant data for the data storage system.

Please refer to FIG. 1B. FIG. 1B illustratively shows a storage format of data stored in the data storage devices (12a˜12d). As shown in FIG. 1B, each of the data storage devices (12a˜12d) is being divided into a plurality of sectors. From the viewpoint of fault tolerance, the plurality of sectors can be divided into two kinds of sectors which are the target data sectors and the parity data sectors. The target data sectors store general user data. The parity data sectors store the remaining parity data to provide to calculate the user data when the fault tolerant is required.

In the case shown in FIG. 1B, the data storage device 12a at least includes the target data sectors D0, D3, D6, and the parity data sector P3; the data storage device 12b at least includes the target data sectors D1, D4, D9, and the parity data sector P2; the data storage device 12c at least includes the target data sectors D2, D7, D10, and the parity data sector P1; the data storage device 12d at least includes the target data sectors D5, D8, D11, the parity data sector P0, etc.

The corresponding target data sectors and the parity data sector in different data storage devices form a stripe, where data in the parity data sectors is a result of Exclusive OR (XOR) operation executed on the data in the target data sectors. In the case shown in FIG. 1B, the target data sectors D0, D1, D2 and the parity data sector P0 form a stripe S1, where the data in the parity data sector P0 is a result of Exclusive or (XOR) operation executed on data in the target data sectors D0, D1, D2. Similarly, the target data sectors D3, D4, D5 and the parity data sector P1 form another stripe S2, where the data in the parity data sector P1 is a result of Exclusive or (XOR) operation executed on data in the target data sectors D3, D4, D5. Similarly, the target data sectors D6, D7, D8 and the parity data sector P2 form another stripe S3, where data in the parity data sector P2 is a result of Exclusive or (XOR) operation executed on data in the target data sectors D6, D7, D8. Similarly, the target data sectors D9, D10, D11 and the parity data sector P3 form another stripe S4, where the data in the parity data sector P3 is a result of Exclusive or (XOR) operation executed on data in the target data sectors D9, D10, D11. It needs to be noticed that those of ordinary skill in the art all understand the calculation of the data in the parity data sectors can also be executed by, other than Exclusive or (XOR) operation, various parity operations or similar operations which just have the relationship that data of any sector can be obtained by calculating data of corresponding sectors in the same stripe.

The data storage system 1 applying the RAID technology must first perform a process of RAID creation to define the data storage system 1 itself, and then the data storage system 1 with finished RAID creation is shown to the application I/O request unit 11. At this time, the data storage system 1 is available for the application I/O request unit 11, and also can start to be accessed. Before the data storage system 1 is unavailable for the application I/O request unit 11, the application I/O request unit 11 certainly does not know the existence of the data storage system 1, and cannot access data from the data storage system 1.

A typical method regarding RAID creation mentioned above, firstly, is to setup a RAID configuration, and then to perform a procedure of consistency. After the procedure of consistency is finished, the RAID configuration settings are written into the constituent storage devices. At this time, the process of RAID creation is finished. The main reason of the procedure of consistency performed is that only data in the constituent storage devices, whose procedures of consistency are finished, can be regenerated once the constituent storage devices fail, where said data among the members of the storage device. The means of the procedure of consistency basically is to make the target data and the parity data consistent.

The well-known procedure of consistency is to perform initialization or synchronization in background. Taking the synchronization as an example for explanation, the synchronization of the data storage system 1 is executed, that is to say, to read target data in the target data sectors for each stripe (S1˜S4), then to perform an operation for the read data to generate the corresponding parity data, and then to write the parity data generated into the corresponding parity data sector. Therefore, during the synchronizing process, the controller 10 alternately executes writing commands and reading commands for each storage device (12a, 12b, 12c, 12d), as shown in FIG. 1C. FIG. 1C illustratively shows a situation that reading commands and writing commands are executed on the data storage devices (12a˜12d) during the synchronizing process where the notations marked R represent reading commands, and the notations marked W represent writing commands. Obviously, the synchronization performed for consistency of the data storage system 1 of the prior art is a very time-consuming process. The disadvantage of the synchronization is slow speed of processing, and the advantage of the synchronization is capability of receiving external input/output during the synchronizing process. The initialization is to directly write specific pattern into the data storage devices. The advantage of the initialization is fast speed of processing, and the disadvantage of the initialization is no capability of receiving external input/output during the initialization.

### SUMMARY OF THE INVENTION

Accordingly, one scope of the invention is to provide a data storage system and a synchronizing method for consistency thereof, especially for the data storage system specifying in RAID 5 architecture. And in particular, the synchronizing method according to the invention can significantly reduce synchronization time of the data storage system, and can keep the advantage of receiving external input/output during the synchronizing process.

A data storage system according to a preferred embodiment of the invention includes N storage devices and a controller where N is an integer equal to or larger than 3. The controller is respectively coupled to each of the storage devices, and used to arrange data in the N storage devices. Each of storage devices is divided into a plurality of sectors. The data in the N storage devices have a form consisting of a sequence of stripes. Each of the stripes is formatted such that (N−1) sectors contain target data and the remaining sector contains parity data for the other (N−1) target data sectors. Various sectors containing parity data are distributed/rotated among the N storage devices. The controller is also used to perform the synchronization for consistency of the data storage system, and firstly, to designate one among the N storage devices. Then, the synchronization performed by the controller is for each stripe to perform the steps of: reading data from each sector other than the sector of the designated storage device; performing a predetermined operation for the read data to generate an operational result; and writing the operational result into the sector of the designated storage device.

A synchronizing method according to a preferred embodiment of the invention is performed for consistency of a data storage system. The data storage system includes N storage devices, where N is an integer equal to or larger than 3. Data are arranged in the N storage devices. Each of the storage devices is divided into a plurality of sectors. The data in the N storage devices have a form consisting of a sequence of stripes. Each of the stripes is formatted such that (N−1) sectors contain target data and the remaining sector contains parity data for the other (N−1) target data sectors. Various sectors containing parity data are distributed/rotated among the N storage devices. The synchronizing method according to the invention, firstly, is to designate one among the N storage devices. Then, the synchronizing method according to the invention is for each stripe to perform the steps of: reading data from each sector other than the sector of the designated storage device; performing a predetermined operation for the read data to generate an operational result; and writing the operational result into the sector of the designated storage device.

In one embodiment, the operational result is for one of the target data or the parity data of said one stripe.

In one embodiment, the format of the data arranged in the N storage devices is specified in a RAID 5 architecture.

In one embodiment, the predetermined operation is an Exclusive OR (XOR) operation.

In one embodiment, each of the storage devices can be a tape drive, a disk drive, a memory device, an optical storage drive, a sector corresponding to a single read-write head in the same disk drive, or other equivalent storage devices.

The advantage and spirit of the invention may be understood by the following recitations together with the appended drawings.

### BRIEF DESCRIPTION OF THE APPENDED DRAWINGS

FIG. 1A is a schematic diagram showing the architecture of a conventional data storage system 1 specified in RAID 5 architecture.

FIG. 1B illustratively shows a storage format of data stored in the data storage devices (12a˜12d) shown in FIG. 1A.

FIG. 1C illustratively shows a situation that reading commands and writing commands are executed on the data storage devices (12a˜12d) during the synchronizing process of prior art.

FIG. 2A is a schematic diagram showing the architecture of a data storage system 2 according to a preferred embodiment of the invention and specified in RAID 5 architecture.

FIG. 2B illustratively shows a storage format of data stored in the data storage devices (22a˜22d) shown in FIG. 2A.

FIG. 2C illustratively shows a situation that reading commands and writing commands are executed on the data storage devices (22a˜22d) during the synchronizing process according to the invention.

FIG. 3 is a flow diagram illustrating a synchronizing method 3 according to a preferred embodiment of the invention.

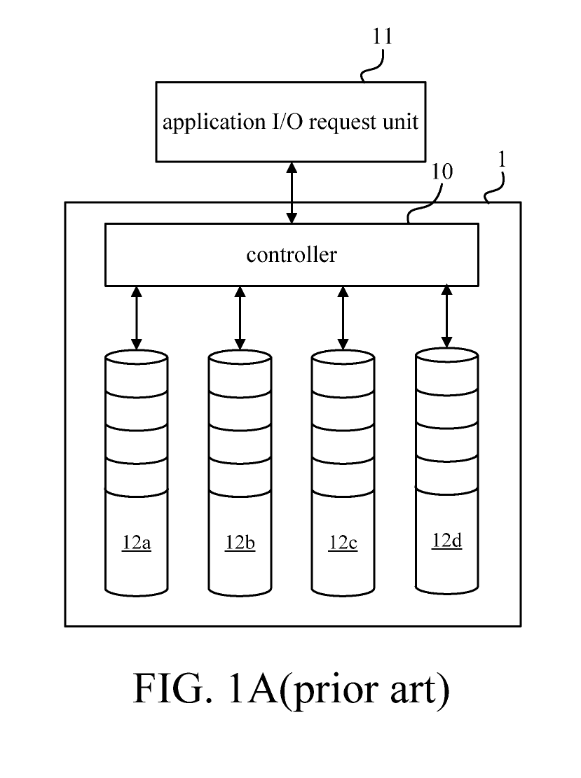

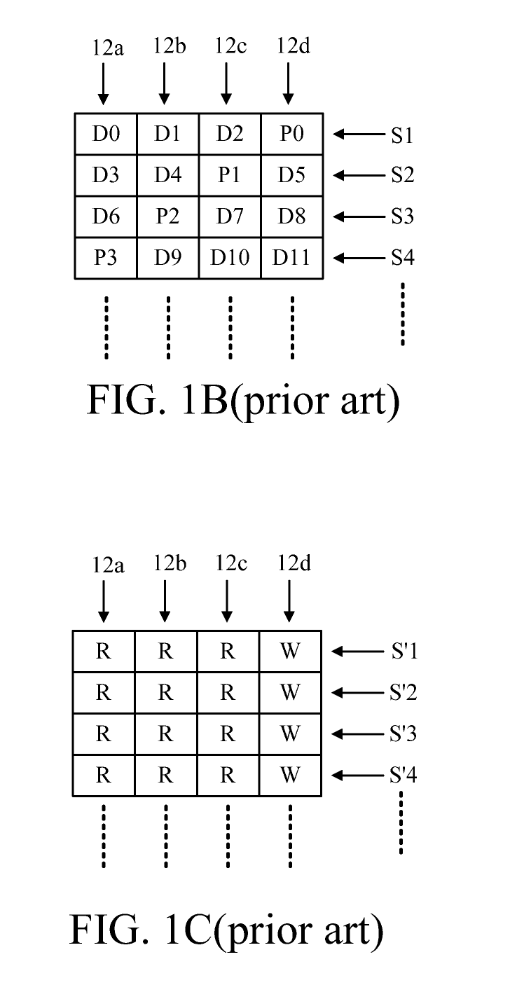

### DETAILED DESCRIPTION OF THE INVENTION

The invention is to provide a data storage system and a synchronizing method for consistency thereof, especially for the data storage system specified in RAID 5 architecture. In particular, the synchronizing method according to the invention can significantly reduce synchronization time of the data storage system and can keep the advantage of receiving external input/output during the synchronizing process. Some preferred embodiments and practical applications of this present invention would be explained in the following paragraph, describing the characteristics, spirit, advantages of the invention, and feasibility of embodiment.

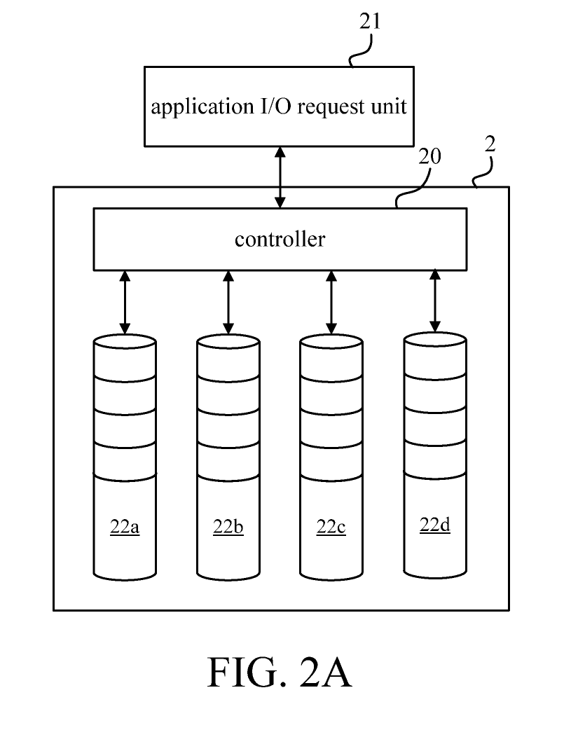

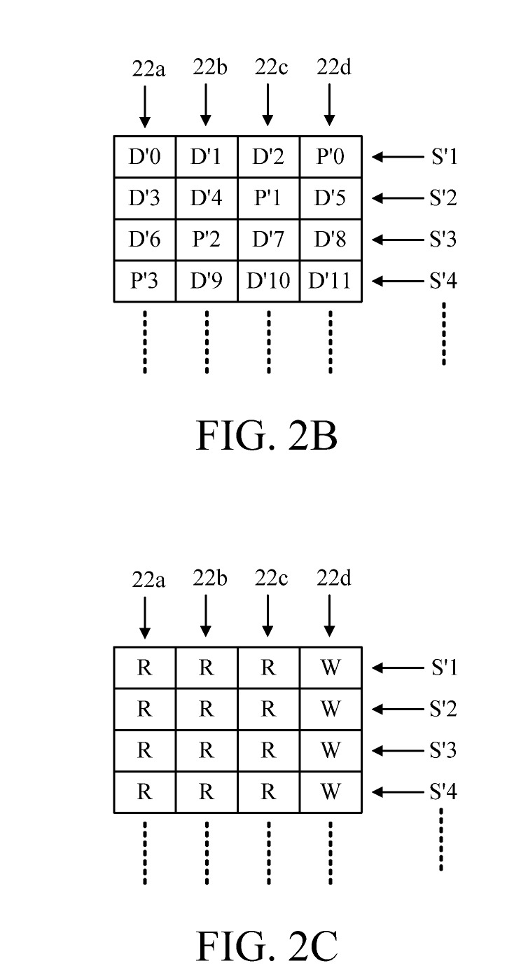

Please refer to FIG. 2A, the architecture of a data storage system 2 according to a preferred embodiment of the invention is illustratively shown in FIG. 2A. The data storage system 2 is specified in RAID 5 architecture.

As shown in FIG. 2A, the data storage system 2 includes a controller 20 and N storage devices (22a˜22d). Because the data storage system 2 shown in FIG. 2A uses RAID 5 of technology, the data storage system 1 needs at least three storage devices. Therefore, N is an integer equal to or larger than 3. FIG. 2A illustratively shows four storage devices (22a, 22b, 22c, 22d) as an example. The controller 20 can generate (reconstruct) redundant data which are identical to data to be read. In this case of utilizing RAID 5 of technology, the controller 20 generates redundant data by Exclusive OR (XOR) operation.

In one embodiment, each of the storage devices (22a, 22b, 22c, 22d) can be a tape drive, a disk drive, a memory device, an optical storage drive, a sector corresponding to a single read-write head in the same disk drive, or other equivalent storage devices.

Also as shown in FIG. 2A, the controller 20 is respectively coupled to each of the storage devices (22a, 22b, 22c, 22d). FIG. 2A also illustratively shows an application I/O request unit 21. The application I/O request unit 21 is coupled to the controller 20. In practical application, the application I/O request unit 21 can be a network computer, a mini-computer, a mainframe, a notebook computer, or any electronic equipment need to reed data in the data storage system 1, e.g., a cell phone, a personal digital assistant (PDA), a digital recording apparatus, a digital music player, and so on.

When the application I/O request unit 21 is a stand-alone electronic equipment, it can be coupled to the data storage system 2 through a transmission interface such as a storage area network (SAN), a local area network (LAN), a serial ATA (SATA) interface, a fiber channel (FC), a small computer system interface (SCSI), and so on, or other I/O interface such as a PCI express interface. In addition, when the application I/O request unit 21 is a specific integrated circuit device or other equivalent devices capable of transmitting I/O read requests, it can send read requests to the controller 20 according to commands (or requests) from other devices, and then read data in the storage devices (22a˜22d) via the controller 20.

The controller 20 and the storage devices (22a˜22d) of the data storage system 2 can not only be placed in an enclosure, but also be separately placed in different enclosures. In practical application, the controller 20 can be coupled to the data storage devices (22a˜22d) through transmission interfaces such as FC, SCSI, SAS, SATA, PATA, and so on. If the data storage devices (22a˜22d) are disk drives, each of data storage devices (22a, 22b, 22c, 22d) could be an interface, such as FC, SCSI, SAS, SATA, PATA, etc., of disk drive different from one another. The controller 20 can be a RAID controller or a controller capable of generating redundant data for the data storage system.

Please refer to FIG. 2B. FIG. 2B illustratively shows a storage format of data stored in the data storage devices (22a˜22d). As shown in FIG. 2B, each of the data storage devices (22a˜22d) is being divided into a plurality of sectors. From the viewpoint of fault tolerance, the plurality of sectors can be divided into two kinds of sector which are the target data sectors and the parity data sectors. The target data sectors store general user data. The parity data sectors store the remaining parity data to provide to calculate the user data, when the fault tolerant is required.

In the case shown in FIG. 2B, the data storage device 22a at least includes the target data sectors D′0, D′3, D′6, and the parity data sector P′3; the data storage device 22b at least includes the target data sectors D′1, D′4, D′9, and the parity data sector P′2; the data storage device 22c at least includes the target data sectors D′2, D′7, D′10, and the parity data sector P′1; the data storage device 12d at least includes the target data sectors D′5, D′8, D′11, the parity data sector P′0, etc.

The corresponding target data sector and the parity data sector in different data storage devices form a stripe, where data in the parity data sectors is a result of Exclusive OR (XOR) operation executed on the data in the target data sectors. In the case shown in FIG. 2B, the target data sectors D′0, D′1, D′2 and the parity data sector P′0 form a stripe S′1, where the data in the parity data sector P′0 is a result of Exclusive OR (XOR) operation executed on the data in the target data sectors D′0, D′1, D′2. Similarly, the target data sectors D′3, D′4, D′5 and the parity data sector P′1 form another stripe S′2, where the data in the parity data sector P′1 is a result of Exclusive OR (XOR) operation executed on the data in the target data sectors D′3, D′4, D′5. Similarly, the target data sectors D′6, D′7, D′8 and the parity data sector P′2 form another stripe S′3, where the data in the parity data sector P′2 is a result of Exclusive OR (XOR) operation executed on the data in the target data sectors D′6, D′7, D′8. Similarly, the target data sectors D′9, D′10, D′11 and the parity data sector P′3 form another stripe S′4, where the data in the parity data sector P′3 is a result of Exclusive OR (XOR) operation executed on the data in the target data sectors D′9, D′10, D′11. Various sectors containing parity data are distributed/rotated among the N storage devices (22a˜22d). It needs to be noticed that those of ordinary skill in the art all understand the calculation of the data in the parity data sectors can also executed by, other than Exclusive OR (XOR) operation, various parity operations or similar operations which just have the relationship that data of any sector can be obtained by calculating data of corresponding sectors in the same stripe.

In particular, the controller 20 is also used to perform the synchronization for consistency of the data storage system 2, and firstly, to designate one among the N storage devices (22a˜22d). Then, the synchronization performed by the controller 20 is for each stripe (S′1, S′2, S′3, S′4, etc.) to perform the steps of: reading data from each sector other than the sector of the designated storage device; performing a predetermined operation for the read data to generate an operational result; and writing the operational result into the sector of the designated storage device.

In one embodiment, the operational result is for one of the target data or the parity data of said one stripe.

In one embodiment, the predetermined operation is an Exclusive OR (XOR) operation.

The storage device 22d is taken as the designating storage device for explanation. In this case, for the synchronization of the stripe S′1, the target data in the target data sectors D′0, D′1, D′2 are read, and the following operation is executed:

D′0⊕D′1⊕D′2=P′0

Then, the calculated P′0 of the above operation is written into the parity data sector P′0 of the designated storage device 22d, i.e., the synchronization of the stripe S′1 is finished.

For the synchronization of the stripe S′2, the target data in the target data sector D′3, D′4 and the parity data in the parity data sector P′1 are read, and the following operation is executed:

D′3⊕D′4⊕P′1=D′5

Then, the calculated D′5 of the above operation is written into the target data sector D′5 of the designated storage device 22d, i.e., the synchronization of the stripe S′2 is finished.

For the synchronization of the stripe S′3, the target data in the target data sectors D′6, D′7 and the parity data in the parity data sector P′2 are read, and the following operation is executed:

D′6⊕D′7⊕P′2=D′8

Then, the calculated D′8 of the above operation is written into the target data sector D′8 of the designated storage device 22d, i.e., the synchronization of the stripe S′3 is finished.

For the synchronization of the stripe S′4, the target data in the target data sector D′9, D′10 and the parity data sector P′3 are read, and the following operation is executed:

D′9⊕D′10⊕P′3=D′11

Then, the calculated D′11 of the above operation is written into the target data sector D′11 of the designated storage device 22d, i.e., the synchronization of the stripe S′4 is finished.

After the synchronization of all the stripes (S′1˜S′4, etc.) is finished, the synchronization of the data storage system 2 is finished. The storage device 22d is taken as the designating storage device for explanation. The controller 20 performs only reading commands for the storage devices (22a, 22b, 22c), and performs only writing commands for the storage device 22d, as shown in FIG. 2C. On the premise of the storage device 22d taken as the designating storages device for explanation, FIG. 2C illustratively shows a situation that reading commands and writing commands are executed on the data storage devices (22a˜22d) during the synchronizing process where the notations marked R represent the reading commands, and the notations marked W represent the writing commands. Obviously, comparing with the synchronizing method for consistency of the data storage system 1 of the prior art, the synchronization according to the invention can substantially reduce synchronization time of the data storage system 2.

It needs to be stressed that the data storage system 2 according to the invention still keeps the advantage of receiving external input/output during the synchronizing process. This case shown in FIG. 2B is taken as an example for explanation. When the synchronizing method according to the invention is performed in step of the stripe S′2, and at this time, if the target data is written into the stripe S′4 early, it will not affect the accuracy of data in the stripe S′4 whose synchronization is subsequently finished.

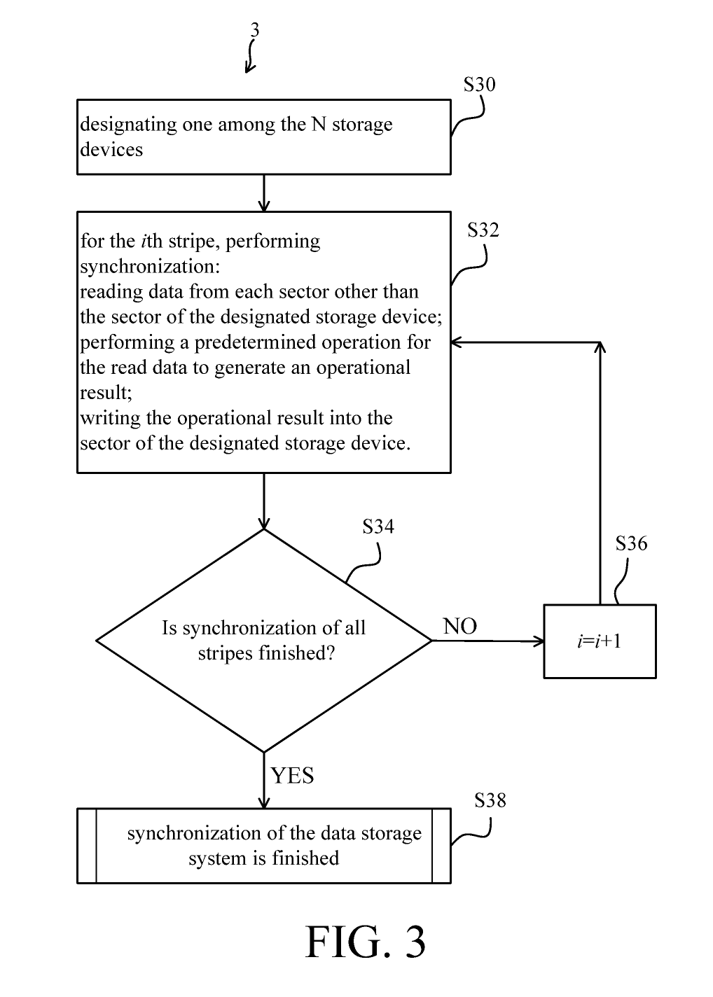

Please refer to FIG. 3. FIG. 3 is a flow diagram illustrating a synchronizing method 3 according to a preferred embodiment of the invention. The synchronizing method 3 according to the invention is performed for consistency of the data storage system 2, for example, shown in FIG. 2. The architecture of the data storage system 2 has been described in detail above, and it will not be described again here.

As shown in FIG. 3, the synchronizing method 3 according to the invention, firstly, performs step S30 to designate one among the N storage devices.

Then, the synchronizing method 3 according to the invention performs step S32 to perform for the ith stripes the steps of: reading data from each sector other than the sector of the designated storage device; performing a predetermined operation for the read data to generate an operational result; and writing the operational result into the sector of the designated storage device.

Then, the synchronizing method 3 according to the invention performs step S34 to judge if synchronization of all stripes is finished. If the judgment in step S34 is NO, the synchronizing method 3 according to the invention will perform step S36 to make i=i+1. After step S36, the synchronizing method 3 according to the invention repeats step S32.

If the judgment in step S34 is YES, the synchronizing method 3 according to the invention will perform step S38 to prompt that synchronization of the data storage system has been finished.

With the detailed description of the above preferred embodiments of the invention, it is clear to understand that the synchronizing method provided by the invention enable to significantly reduce synchronization time of the data storage system, and to keep the advantage of receiving external input/output during the synchronizing process.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A synchronizing method for consistency of a data storage system comprising N storage devices where data are arranged, N being an integer equal to or larger than 3, wherein each of the storage devices is divided into a plurality of sectors, the data in the N storage devices have a form consisting of a sequence of stripes, each of the stripes is formatted such that (N−1) sectors contain target data and the remaining sectors contain parity data for the other (N−1) target data sectors, various sectors containing parity data are distributed/rotated among the N storage devices, said synchronizing method comprising the steps of:
designating one among the N storage devices; and
for each stripe, performing the steps of:
reading data from each sector other than the sector of the designated storage device;
performing a predetermined operation for the read data to generate an operational result; and
writing the operational result into the sector of the designated storage device.

2. The synchronizing method of claim 1, wherein the operational result is for one of the target data or the parity data of said one stripe.

3. The synchronizing method of claim 2, wherein the predetermined operation is an Exclusive OR (XOR) operation.

4. The synchronizing method of claim 3, wherein the form of the data arranged in the N storage devices is specified in a RAID 5 architecture.

5. The synchronizing method of claim 4, wherein each of the storage devices is one selected from the group consisting of a tape drive, a disk drive, a memory device, and an optical storage drive.

6. A data storage system, comprising:
N storage devices where data are arranged, N being an integer equal to or larger than 3;
a controller, respectively coupled to each of the storage devices, for arranging data in the N storage devices, wherein each of storage devices is divided into a plurality of sectors, the data in the N storage devices have a form consisting of a sequence of stripes, each of the stripes is formatted such that (N−1) sectors contain target data and the remaining sectors contain parity data for the other (N−1) target data sectors, various sectors containing parity data are distributed/rotated among the N storage devices, and the controller performing for consistency of said data storage system the synchronization steps of:
designating one among the N storage devices; and
for each stripe, performing the steps of:
reading data from each sector other than the sector of the designated storage device;
performing a predetermined operation for the read data to generate an operational result; and
writing the operational result into the sector of the designated storage device.

7. The data storage system of claim 6, wherein the operational result is for one of the target data or the parity data of said one stripe.

8. The data storage system of claim 7, wherein the predetermined operation is an Exclusive OR (XOR) operation.

9. The data storage system of claim 8, wherein the form of the data arranged in the N storage devices is specified in a RAID 5 architecture.

10. The data storage system of claim 9, wherein each of the storage devices is one selected from the group consisting of a tape drive, a disk drive, a memory device, and an optical storage drive.
